(19) United States
(12) Patent Application Publication
(10) Pub. No.: US 2014/0368530 A1
(43) Pub. Date: Dec. 18, 2014

(54) Illumination Synchronizer

(71) Applicant: PORTRAIT DISPLAYS, INC., Pleasanton, CA (US)

(72) Inventors: J. Michael James, San Francisco, CA (US); Eric Brumm, Dublin, CA (US)

(21) Appl. No.: 13/918,805

(22) Filed: Jun. 14, 2013

(51) Int. Cl. G06Q 30/06; G06T 11/00

(52) U.S. Cl. CPC G06Q 30/0643; G06T 11/001
USPC 345/593

(57) ABSTRACT

Methods and systems are provided for providing a selection of light conditions under which to view digitally depicted objects on a client device. For example, where website provides a digital color picture of an object, the invention provides selections on a display device to view the object in different simulated lighting conditions thereby enabling an object's color to be viewed as it will appear when illuminated under various light conditions. In accordance with embodiments of the invention disclosed herein, methods and systems are provided for an application on a user device that changes the color settings and/or white point settings of the user device's display, or portions of the user device's display, so that photographs of items may be presented on the user device's display as if the photographs were taken under various lighting conditions, such as sunlight, incandescent light, fluorescent light, candle light, and/or other light sources.

### FIELD OF THE INVENTION

The present invention relates generally to electronic display color settings, and more particularly but not exclusively to synchronizing, managing and adjusting the virtual illumination of an item being displayed to reflect different ambient light environments.

### BACKGROUND

The human eye is very sensitive to small changes in color. People are able to determine, for example, when the colors of an item represented on a display screen are different from the actual colors of the item observed directly. For eCommerce purposes, the colors of an item viewed on a device's display screen should be the actual colors of the item being represented, but the human eye often does not perceive them this way. One reason for this is that the screen image is created by light emitted from the display, which then passes into the viewer's eye, but the colors of an actual item viewed directly are created by ambient light bouncing off the item and reflecting into the viewer's eye.

White light has a color. This is referred to as the color temperature or white point. The temperature is measured in degrees Kelvin (K). The degrees are the same distance apart as Celsius (C) degrees but the number system starts at absolute zero (−273.15° C.). Higher temperatures such as 9000 degrees K, denotes a cool bluish color of white. A lower temperature, 3000 degrees K as an example, denotes a warmer color of white with a red or orange tinge. Candle light, tungsten incandescent bulbs, and fire light are in the 2500 degrees K range. Most computer screens and overhead florescent lights are in the 8000+ degree K range. The standard for sRGB color calibration is 6500 degrees K (also described as D65). All these white colors would be considered white if viewed in isolation. When viewed together, however, the tints in the white are clear.

There is an existing problem that concerns perceived color differences between a photograph of an object displayed on a screen and the same object viewed under varying ambient light. As an example; during an eCommerce purchase, an item displayed on a device's screen that was photographed in florescent light will look different than the actual item when it arrives and is viewed under tungsten incandescent ambient light. An actual item's perceived color is determined by the color characteristics of the reflective white light used to illuminate it. The color of the ambient light has very large effect on the color of an item where the eye is seeing light reflected off the item. However, ambient light has very little effect on the color of an item represented by viewing an image on a screen. A screen emits its own light and is not dependent on ambient light for illumination.

Preferred embodiments of the present invention help to solve a common problem; the difference between the perceived color of an image of an item on a device's screen and the actual color of the object when viewed in different ambient light situations. Preferred embodiments of the invention allow users to have confidence that the color represented on their device's display is the actual color of the item in the environment in which they expect to use the item. This is most important in eCommerce where a user investigates or purchases an item from a Web site and the purchase decision is based, in part, on the color perceived by the user on the display. The invention allows the buyer to adjust the display screen to mimic the different colors of the ambient white light that will be illuminating the item when used.

There is therefore a need for an easy-to-use tool to change the color of white values or color of white settings of a digital image on a display to mimic the color of an item for purchase under various white light conditions.

### BRIEF SUMMARY

In preferred embodiments of the invention, methods and systems are provided for allowing the display to adjust the color of a displayed object to reflect how the human eye will perceive that color when the object is actually viewed under various ambient light conditions.

In accordance with aspects of preferred embodiments, methods and systems are provided for providing an application that changes the color of white settings or white point of a display, or portions of a display, so that the color of a photographed item being displayed may be perceived as if the photographs were taken under various lighting conditions, such as sun light, incandescent light, fluorescent light, candle light, and/or other light sources.

In accordance with preferred embodiments, methods and systems are provided to operate the invention in conjunction with displays that use a Monitor Command and Control Set (MCCS) standard, where the client device allows for changing white point via Video Electronics Standards Association (VESA) Display Data Channel Command Interface Standard (DDC/CI), and in conjunction with displays that can be controlled via a lookup table (LUT) method, whereby a LUT is generated for display devices that do not directly support color of white adjustment.

This brief summary is provided to introduce a selection of concepts in a simplified form that are further described in the detailed description. It is not intended to be exhaustive or to limit the inventions to the precise forms disclosed.

### BRIEF DESCRIPTION OF THE DRAWINGS

Preferred embodiments of the present invention are illustrated by way of example, and not by way of limitation, in the figures of the accompanying drawings and in which like reference numerals refer to similar elements and in which:

FIG. 1 is an exemplary illustration of a system diagram depicting aspects of a preferred embodiment of the invention.

FIG. 2a is a flow diagram of a method for synchronizing the illumination of an object according to aspects of some embodiments of the invention.

FIG. 2b is a flow diagram of a method for allowing a user to alter the illumination of an object according to some aspects of a preferred embodiment of the invention.

FIG. 3 is an exemplary system diagram depicting aspects of a preferred embodiment of the invention.

FIG. 4 is an exemplary system diagram depicting the use of a computer system for implementing aspects of preferred embodiments of the invention.

### DETAILED DESCRIPTION OF PREFERRED EMBODIMENTS OF THE INVENTION

Other and further features and advantages of the present invention will be apparent from the following descriptions of the various embodiments when read in conjunction with the accompanying drawings. It will be understood by one of ordinary skill in the art that the following embodiments are provided for illustrative and exemplary purposes only and that numerous combinations of the elements of the various embodiments of the present invention are possible.

Human perception of color is composed of three separate light sensors in the eye: red, green, and blue. Each of these sensors detects various levels of intensity. Colors are made up of combinations of red, green, and blue light at various intensities. Based on these combinations, the human eye can see over 16 million different colors. The human eye is very sensitive to small changes in color, including color differences that result from an item with a fixed absolute color being illuminated by varying light sources that have a different color of white.

The perceived color of an item is created by ambient light bouncing off the item and reflecting into a viewer's eye.

An item's perceived color is thus determined by the color characteristics of the reflective white light used to illuminate it. Depending on what light source is illuminating an item, its color is perceived differently by a human eye. When photographed, the color of an item captured in the photograph depends both on the absolute color of the item and on the light used to illuminate the item. For example, the color of a red shirt captured in two photographs—one in bright sunlight and the other in candlelight—will be perceived by a human eye to be different colors of red.

When purchasing an item, a person may wish to view the item under various ambient light conditions to assess the appearance of the item's color under such different light conditions. As an example, if the item on a device's screen was photographed in florescent light and a customer buys the item based on the screen image, then when the item arrives and is viewed under tungsten incandescent light, the colors of the item will be perceived as very different from the screen image. The color of white of the ambient light has very large effect on the color of an item where the eye is seeing light reflected off the item.

An image appearing on a digital display or screen is created by light emitted from the display or screen, which passes into a viewer's eye. Colors appearing on a display are governed by certain characteristics:

1. Chromaticity—the amount of red, green, or blue comprising a color on the display.

2. White point or color of white—this is the color value of the maximum white level.

3. Gamma—this is the non-linear relationship between the increase in a value of the red, green, or blue signal and the increase in the red, green, or blue brightness or luminance.

If any of these color settings is changed, then the visually-perceived colors will be different.

White point or color of white, often referred to as reference white or target white, is a set of chromaticity coordinates. Chromaticity is an objective specification of the quality of a color regardless of its luminance, that is, as determined by its hue and colorfulness (or saturation, chroma, intensity, or excitation purity). A display's or illuminant's white point or color of white is a neutral reference characterized by a chromaticity. White point or color of white is only related to color and unaffected by intensity.

Chromaticity coordinates serve to define the color “white” in image capture, encoding, reproduction, or display. Depending on the application, the color “white” may need to be defined differently. For example, a picture of a white piece of paper taken indoors with incandescent lighting will provide more of an orange color compared to a photograph of the same piece of paper taken in direct equatorial mid-day sunlight. Thus, “white” needs to be defined differently for various light conditions.

An illuminant is a theoretical source of visible light with a known profile (a “spectral power distribution”). Standard illuminants provide a basis for comparing the color of objects photographed under different lighting conditions. The white point or color of an illuminant is the chromaticity of a white object under the illuminant. For example, it is the color of a piece of white paper under florescent light, or incandescent light, or direct sunlight, or candle light.

White point or color of white is also referred to as color temperature. Color temperature is measured in degrees Kelvin (K). Higher temperatures, such as 9000 degrees K, denote a cool blue tint of white. Lower temperatures, such as 3000 degrees K, denote a warm red or orange tint of white. Candle light, tungsten incandescent bulbs, and fire light are in the 2500 degrees K range. Most computer screens and overhead florescent lights are in the 8000+ degree K range. The standard for sRGB color calibration is 6500 degrees K.

White point is critical in altering the color settings of a digital image of an object to display how the actual object will appear under various lighting conditions. On a digital display, white point or color of white can be modified by changing the color settings on the display. By changing the white point or color of white settings of display that is showing a digital photograph, it is possible to present a digital photograph to a user as if it were taken under various lighting conditions. For example, by changing the white point characteristics of a picture of a red shirt, the display can show a red shirt as it would appear in mid-afternoon equatorial sun, incandescent light, or candle light.

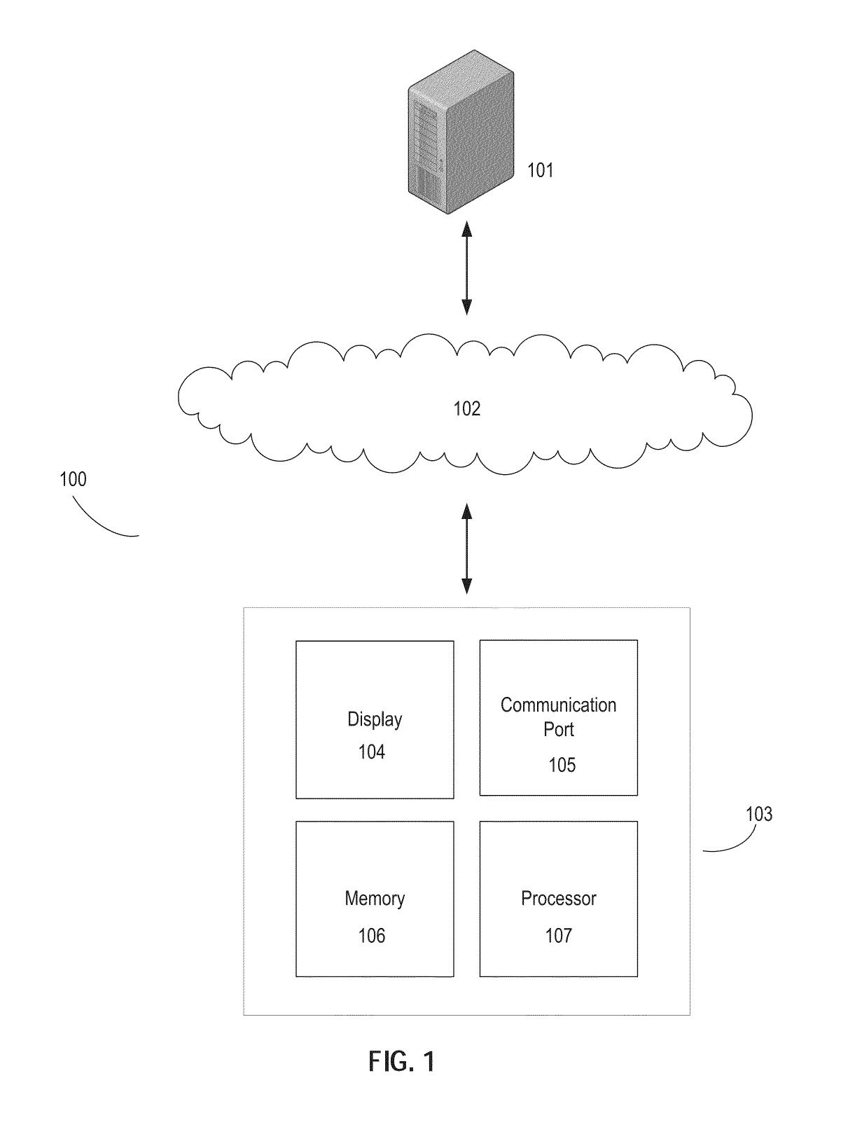

FIG. 1 shows an exemplary and non-limiting diagram of a system 100 utilized to describe the various embodiments of the invention. The system 100 includes a client device 103 connected to one or more servers 101 (hereinafter server 101) through a network 102, which may be either a wireless or wired network such as the Internet. Server 101 hosts web pages and images. In the case of eCommerce, photography is often used to capture an image of an item to be displayed for sale on a web page. The image is transferred from the capture device to a source display for editing and preparation before it is made available by servers 101 hosting the eCommerce website. Server 101 communicates with the client device 103, comprising a display 104, a communication port 105, memory 106, and a processor 107, via the network 102. The client device 103 receives images from websites and presents the images on the display 104. The client device 103 can also present images on the display 104 that are stored in the memory 106. The display 104 is typically driven by a computing device and may be integral with a television, monitor, notebook, tablet, phone, or other electronic device 300. Computing devices usually include a browser or other program for browsing and viewing pages on the Internet and/or other networks. The display 104 on the client device 103 is the screen being presented to the user. The display 104 on a client device 103 can be on a monitor, a notebook computer, a tablet computer, a smart phone, or any combination of these devices. All client devices 300 consist of a display driven by a computing device. The colors on the client display are created by light emitted from the device screen.

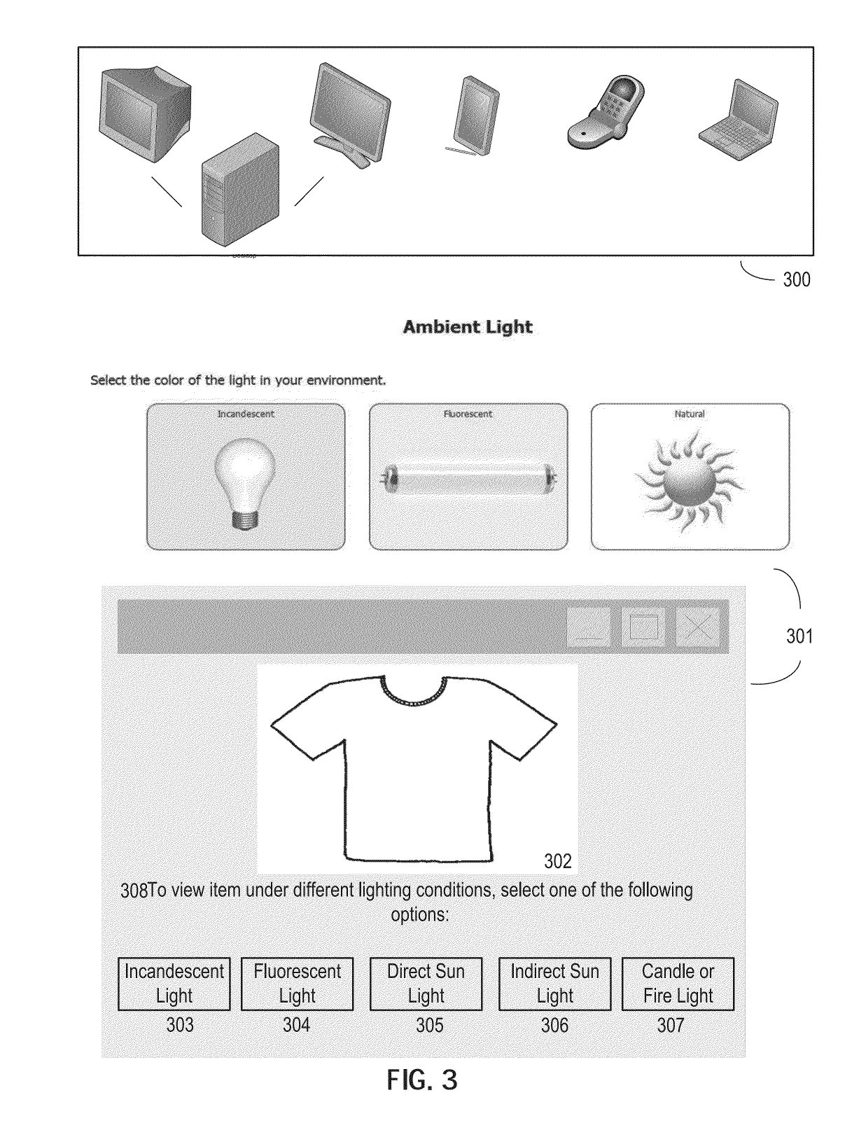

FIG. 3 shows an exemplary and non-limiting diagram of potential client devices 300 and user interfaces 301 for the client devices. On the client device 300, a user interface is presented 301. The user interface 301 presents an image of an item for sale 302 and an option to view the item for sale 302 under different lighting conditions 308, including incandescent light 303, fluorescent light 304, direct sun light 305, indirect sun light 306, and candle or fire light 307. A lighting condition can refer to illumination devices, such as tungsten bulbs, incandescent light, compact fluorescent light, fluorescent tubes, halogens, LED lights, direct sun light, indirect sun light, and candle or fire light, or to the type of light, such as blue light, cool white, reddish light, bright white light, warm white, sun light, full spectrum, and daylight, or to the correlated color temperature (“CCT”), which is provided in degrees Kelvin, or to the Illuminant, such as standard known Illuminants A-F, which are listed in the chart above. The user interface 301 on the client device 300 can list many or just a few lighting condition options 303-307 under which to view an item for sale 302.

Selections of different lighting conditions 303-307 are received by the user interface 301 on the client device 300, and in response to a selection, the color settings on the client device 300 are changed. The color settings of the entire display 104 can be changed or the color settings of only a portion of the display (for example, the pixels of the display that are used to present the image) can be changed, leaving the color settings of the rest of the display unchanged. The images of an item for sale 302 can be images that are hosted on a website or they can also be images that reside on the client device. For example, a user shopping in-person for items can take pictures of those items and then view them under different lighting conditions on her own client device.

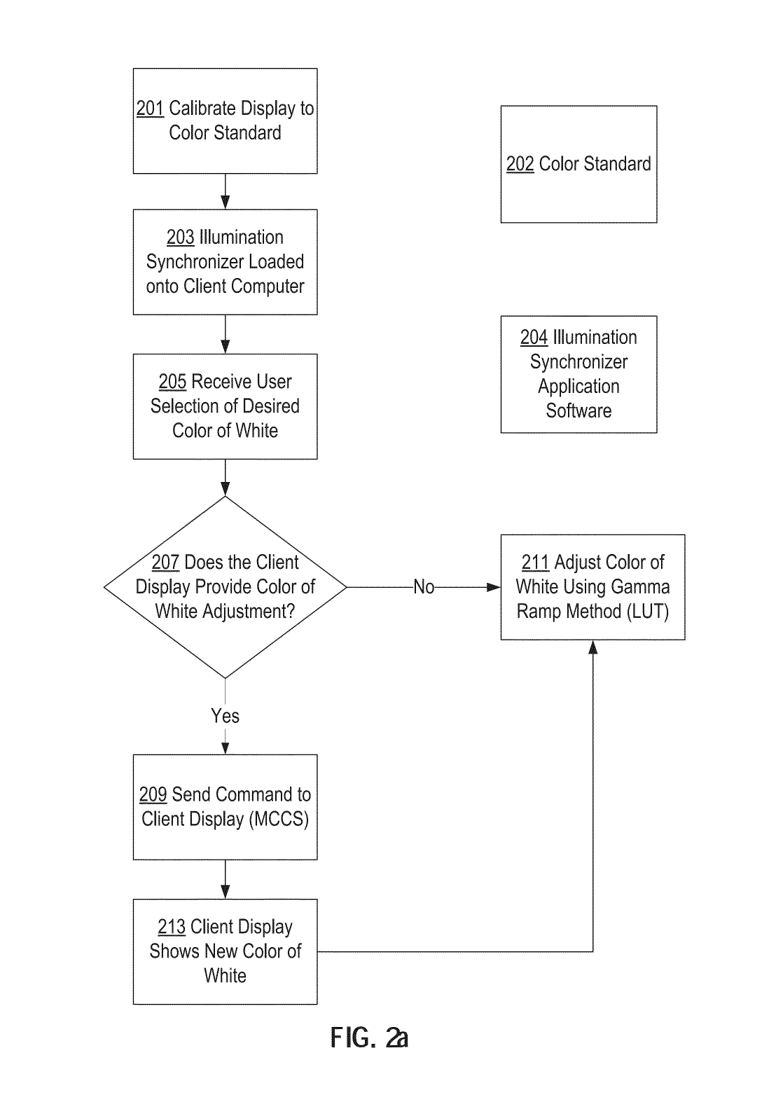

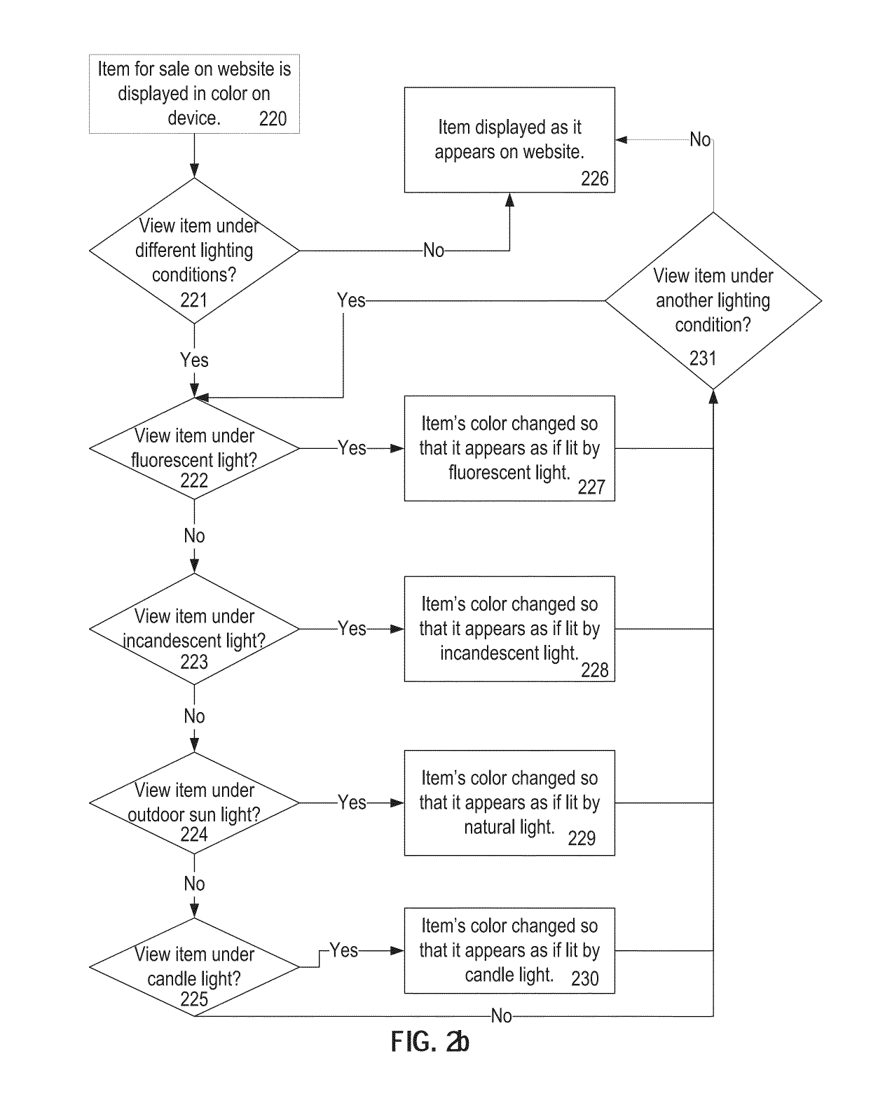

Exemplary and non-limiting methodologies for using preferred embodiments of the invention are provided in FIGS. 2a and 2b. In FIG. 2a at step 201, the display is calibrated to meet a specific white point or color of white such as 6500 degrees K. Additionally, values for color characteristics for the color standard may further include, but are not limited to, resolution, contrast, luminance, brightness, hue, saturation, black point, RGB value, chroma, primary and secondary colors, color space, CIE value, or color spectra. As part of the calibration, compensation values are loaded into the display's color converter so that the results of colors sent to the display meet the calibration specification for the color standard 202. The compensation values can be determined by measuring the display's output colors with a colorimeter, determining the difference between the current output colors and the desired calibrated output colors, and determining compensation values to adjust the output colors to make them the same as the desired colors. Alternatively, the converter can be turned on and off instantly to invoke the calibrated colors and to override the display's default set of color characteristics. After the client display is calibrated, the initial application of the color standard is optional, as the color standard may be applied later on the client device. A lookup table (LUT) for each desired target white point can be created.

LUT is a device for adjusting colors between a computer and a display. Colors on a display are controlled by three variables: one for red, one for blue, and one for green. Each variable consists of a numerical value, typically ranging from zero to 255. The numerical value of the variable corresponds to intensity. For example, if the values of the red, blue, and green variables are equal, then the display will appear white with no color. At values of 255, 255, and 255, the display will show a pure bright white with no color, whereas at values of 100, 100, and 100, the display will show a grey white with no color. If the values of the red, blue, and green variables are not equal, then the display will appear to be a non-white color. At values of 100, 200, and 100, the display will appear blue.

As the values of the three variables are sent from the computer to the display they pass through a LUT. The LUT allows the values to be changed to alter the color of white. For example, if a more blue color of white is desired, then extra values are added to the blue variable's value in the LUT so that 0, 0, 0 is changed to 0, 2, 0 or 250, 250, 250 is changed to 250, 252, 250. In other words, 2 is added to every number of blue from 0 to 255. When these numbers are converted to light to be displayed on the screen, the blue color is enhanced in the white and the color of white becomes more bluish. Thus, the LUTs perform the color of white adjustments. The LUT can be in the display, in which case it is addressed via a command set sent from the computer, or it can be in the computer, in which case it is manipulated directly via a software application.

At step 203, values corresponding to the color standard 202 are loaded into the illumination synchronizer application residing on the client device. At step 205, the Illumination Synchronizer User Interface (UI) operates to provide selections for a desired white point or color of white. Upon receipt of a selection of a desired color of white, the illumination synchronizer application will decide which of two methods of the color temperature control 207. At step 209, the illumination synchronizer application will send a command to the display to change the color temperature to one selected in step 205. At step 209, the illumination synchronizer application will send a command to the display to change the color temperature to one selected in step 205. If the display device does not directly support color of white adjustment, then at step 211, the illumination synchronizer application uses a LUT to adjust the white point. At step 213, the illumination synchronizer application provides the selected color of white.

FIG. 2b is a flow chart explaining a preferred embodiment of the invention. An item for sale on a website is displayed on the client device 220. As disclosed herein, this item can also be a picture of an item that is residing in the memory of a client device. A prompt asks whether to view the item under different lighting conditions 221. If a positive response is received, then additional options to view the item under different lighting conditions 222-225 are provided. If a negative response is received, then the image is presented as it appears on the website (or on the client device) without making any changes to the color settings of the display or the color of the image 226.

At 222, a prompt asks whether to view the item under fluorescent lighting conditions. If a positive response is received, then the color settings of the display are changed to simulate as if the image were being viewed under fluorescent light conditions and the resulting changed image 227 is presented, which is accomplished as described herein and discussed below. A prompt then asks whether to view the item under another lighting condition 231. If a positive response is received, then steps 222-231 are repeated. If a negative response is received, then the image is presented as it appears on the website (or on the client device) without making any changes to the color settings.

At 223, a prompt asks whether to view the item under incandescent lighting conditions. If a positive response is received, the color settings of the display or the color of the image are changed to simulate as if the image were being viewed under incandescent light conditions and the resulting changed image 228 is presented. A prompt then asks whether to view the item under another lighting condition 231. If a positive response is received, then steps 222-231 are repeated. If a negative response is received, then the image is presented as it appears on the website (or on the client device) without making any changes to the color settings of the display or the color of the image 226.

At 224, a prompt asks whether to view the item under incandescent lighting conditions. If a positive response is received, the color settings of the display or the color of the image are changed to simulate as if the image were being viewed under outdoor light conditions and the resulting changed image 229 is presented. A prompt then asks whether to view the item under another lighting condition 231. If a positive response is received, then steps 222-231 are repeated. If a negative response is received, then the image is presented as it appears on the website (or on the client device) without making any changes to the color settings of the display or the color of the image 226.

At 225, a prompt then asks whether to view the item under candle lighting conditions. If a positive response is received, the color settings of the display or the color of the image are changed to simulate as if the image were being viewed under candle light conditions and the resulting changed image 230 is presented. A prompt then asks whether to view the item under another lighting condition 231. If a positive response is received, then steps 222-231 are repeated. If a negative response is received, then the image is presented as it appears on the website (or on the client device) without making any changes to the color settings of the display or the color of the image 226.

Preferred embodiments of the invention assume that the device screen has been color synchronized with a website. Color synchronization means that the actual color of the item displayed on the website matches the colors on the screen when both are illuminated by the same color of white light. The viewing device must be color calibrated to the same color standards used by the website. However, if the purchaser receives the actual item and then views it under different ambient light conditions, then the perceived color will not match the color displayed on the screen at the time of purchase. The invention adjusts the device screen to different simulated ambient light conditions to see how the perceived colors change.

In a typical example, an item on an eCommerce website will be viewed by a web browser on a client display. The item is seen as having a certain color. The item on the website is illuminated by a white light set at 6500 degrees K. The invention provides for viewing the item's colors under a tungsten incandescent bulb, which provides an orange-yellow color of white light of 2500 degrees K. The invention provides for the adjustment of the color of white color settings of the item to allow an on-screen simulation of how the item's color will look with a orange-yellow color of white.

The source display is the device used by the eCommerce manager to prepare the images of items to be inserted onto a website on the Internet. The operator of the source display uses photography to capture an image of the actual item to be displayed. The item to be photographed is illuminated by white light set to a specific color; 6500 degrees K is the common standard. The image goes from the capture device to the source display for editing and preparation to be put on the website's servers. Both the source and the client displays are color calibrated to 6500 degrees K. An item on a website will appear to have the same color characteristics as the item represented on the device's screen.

A person having ordinary skill in the art will understand that the invention can operate on various types of client devices with various color control settings, color calibrations, or mechanisms for affecting color settings on a display. For example, some client devices are color calibrated to sRGB color standard. Being color calibrated means the device can be put into a known color state of 6500 degrees K. Other client devices have color settings that are measured during manufacturing and then have reference color settings installed that establish a default color setting. For such client devices, the default reference setting includes a 6500 degree K color of white. On all of the above types of client devices, any color of white changes on the devices are made from the known color state or reference setting of 6500 degree K. The color of white adjustments made by the invention on such client devices constitute offsets to the known 6500 degrees K state. Thus, changing an image to have a color of white setting of 3500 degrees K translates into the default white minus 3000 degrees K. Changing an image to have a white setting of 8000 degrees K translates into the default white plus 1500 degrees K.

The virtual illumination of an item being displayed on the website can be adjusted to reflect different ambient light environments through a series of steps as follows:

(1) The manufacturer of the client display has the display device calibrated to a color standard. The standard is composed of chromaticity values, gamma values, and a specific 6500 degrees K color of white value. The device is now viewed as color calibrated to the same specifications as websites that provide images of items for sale.

(2) Once these values are established, they are loaded into application software on the client device. The device has white values that are adjustable by the user. In default state the white is set to 6500 degrees K. As the color settings of each pixel go from a device's processor to the screen, they pass through a LUT. The LUT makes the color of white changes, which take place instantly.

(3) A user interface is available on the client device to adjust the color of white in one of three ways: (a) The adjustment can be arranged on a scale calibrated in degrees K. (b) The adjustment can be provided by the common names of the illumination devices: tungsten bulb, incandescent, compact fluorescent light, fluorescent tubes, halogens, LED light, direct sun light, and indirect sun light. (c) The adjustment can be provided by naming the type of light: blue light, cool white, reddish light, bright white light, warm white, sun light, full spectrum, and daylight.

In such an embodiment (or similar embodiments), the invention is an application installed on a device that makes white point adjustments. The invention receives selections of ambient light settings and changes a device's screen (or a portion of the device's screen that contains the digital representation of the item) to reflect the ambient light setting selection, presenting the image as it would appear in a different ambient light color. If the invention is closed, then the device's display, or portion of the display, will return to the white point that was set before the application was invoked.

The invention can be used entirely on a client device. It can alternatively be used as an option on a website when a client device views the website. In this embodiment, the invention changes simulated light conditions to see how the item would look under different lighting conditions and all the resulting color changes occur on the client device. A person having ordinary skill in the art will recognize that the invention runs and can be implemented as, for example, a browser extension, a digital overlay on a client device's screen, an automatic pop-up when a user browses to certain websites, an add-on by ecommerce sites, and through other mechanisms disclosed herein and as necessary to implement or to provide the disclosed invention. The invention can alternatively be installed on the device and on a website, in which case it provides the basic synchronization of color between the website and the device screen. If properly installed, the color synchronization will have a 6500 degree K white point. 6500 degrees K will be the illumination of the item when the photo was taken. The device screen is set to 6500 degrees K so that the image appears as the actual color of the item. The invention allows the user to adjust the image on the device to a different color of white so that the user can see how the color of the item will look under different lighting conditions. No change to the website is made.

On most client devices there is an application program interface to control the device's screen's white settings. The application program interface allowing for the control of a device's screen's color of white settings differs depending on the operating system and/or other features of a client device. For example, Apple, Android, and Windows operating systems control white settings on a client device's screens differently. In one embodiment, the invention includes an application that allows any client device's screen's white settings to be changed either automatically or by the user.

On some client devices, the invention operates in conjunction with a display that uses a command set of the Monitor Command and Control Set (MCCS) standard, where the client device allows for changing white via Video Electronics Standards Association (VESA) Display Data Channel Command Interface Standard (DDC/CI). The VESA DDC/CI Standard is used in conjunction with the VESA Monitor Command and Control Set (MCCS) to read and to write commands to the display. These commands alter the LUT in the display. A person having ordinary skill in the art will understand that it is common for standalone displays to support the MCCS standard, but that not all standalone displays support MCCS control of color temperature.

On other client devices, the invention operates in conjunction with displays that do not implement the MCCS Virtual Control Pane (VCP) command for color temperature. For such displays that cannot be controlled via VCP commands, they can be controlled via the lookup table (LUT) method. Using the LUT method for display devices that do not directly support white adjustment a LUT is generated. The LUT can be generated during factory or manufacturing calibration, or the LUT can be created during runtime. The target color of white is achieved by adjusting the ratios among the red, green, and blue pixel values in the LUT.

### Example Specification for Illumination Synchronization

In this example, both the client and the source displays meet the following specification. The color specifications are used in the manufacturing of the device or display:

There are many specifications for color in the Computer and Consumer Electronics industries. They all describe a target color space, a target white point or color of white, a target gamma and a host of other “targets” that define a color space. Two common color spaces are sRGB and Rec. 709, for PCs and video respectively. Unfortunately, the one thing that ALL of the industry specifications have in common is that there are no boundaries or tolerance values to describe when a device is actually “in-spec” or “out-of spec.” This distinction matters because a device that is supposedly tuned to sRGB may display photos inaccurately, or displays that purports to be tuned to Rec. 709 may actually be causing a loss in contrast and detail in the whites and blacks, and inaccurate face tones.

The purpose of the specification, is to formally define a color space based on already existing color spaces (i.e. sRGB and Rec. 709) and to put some boundaries around the target, so that the industry and consumers know that a device that meets this specification actually represents content properly, and devices that do not meet this specification may not represent colors accurately.

1. General Requirements.

1.1 Test Equipment. The reference Color Analyzer is the Minolta CA-210 or equivalent.

1.2 Photometric and Spectra-Radiometer Measurements. For low-level luminance measurements, the Photo Research PR740 will be used. The calibration of the test instrument used shall be traceable to an NBS source. The use of other equipment for qualification and production is acceptable, provided appropriate offsets are applied so that the monitor meets this specification when measured with the PR740 as specified.

1.3 Measurements Systems. The units of measure stated in this document are those established as United States Customary Systems engineering units unless otherwise noted. If metric conversions are needed by the user, the user shall make them using the factors and methods in accordance with ANSI 268-82

1.4 Operating Environment.

Power: 110 VAC 60 Hz

Environment: 24 deg C.±5 deg C. or 75 deg F.±9 deg F.

Dark room: 0.01 Lux, or other light shielding as necessary to insure reliable measurements.

1.5 Measurement Setup.

Viewing direction: perpendicular

Measurement point: Center of screen

Number of Pixels: 500 px or 26 px diameter

Distance (PR740): 500 mm for displays 2750×Pixel size, or 2.54×Screen height

2° (2 degrees) measurements (according to CIE 1931 standard)

1.6 Device Settings.

Device Controls: Set to factory default, or Certification Setting as appropriate

Warm up time: 30 min, or as necessary to ensure reliable measurements

2. Test Requirements.

2.1 Average and Maximum delta E Tolerance.

For all measurements for 1 device: Average delta E=7; Maximum delta E<7.

Average and Max Delta E Tolerances

| | Avg Delta E | Max Delta E |
|---|---|---|
| Start | NA | 7 |
| 24 mo. | 5 | 6 |

2.2 Color Gamut Primary and White. Primary colors and white according to ITU-R BT.709.

| | |
|---|---|
| Rx = 0.6400 | Ry = 0.3300 |
| Gx = 0.3000 | Gy = 0.6000 |
| Bx = 0.150 | By = 0.0600 |
| Wx = 0.313 | Wy = 0.3290 |

A “PASS” for each primary color shall not exceed DeltaE requirements per CIE2000 calculations

2.3 Color Gamma. Gamma of EOTF of 2.2. Twenty measurements of IRE for Red, Green, and Blue will be made for total gamma curve. Gamma calculation will be compliant with IDMS standard. Separated R,G,B Ramp giving 3 gamma values for R, G and B, respectively are measured. Hence giving 3×20 equidistant measurements to assess the gamma of R, the gamma of G, the gamma of B respectively. A “PASS” shall be a deviation of less than +/−0.1, which means:

Gamma (R)=2,2+/−0.1

Gamma (G)=2.2+/−0.1

Gamma (B)=2.2+/−0.1

2.4 Color Fidelity/Test Color Values. A series of 8×8×8 test colors regularity distributed in log RGB space are shown on the display and measured with respect to an ideal, additive display according to our requirements on primaries, white, and gamma. The mean difference between the measured color and the ideal display (measured in CIELAB space) should not exceed DeltaE limits in Table 2.

Test Color Values RGB and xyY Space

| Image | Red | Green | Blue | x | Y | Y |
|---|---|---|---|---|---|---|
| 0001 | 116 | 79 | 69 | 0.404886 | 0.352483 | 0.09595 |
| 0002 | 194 | 150 | 129 | 0.380339 | 0.357803 | 0.35519 |
| 0003 | 94 | 122 | 155 | 0.249294 | 0.266457 | 0.18906 |
| 0004 | 88 | 108 | 67 | 0.337797 | 0.432885 | 0.13231 |
| 0005 | 129 | 128 | 175 | 0.267874 | 0.253470 | 0.23601 |
| 0006 | 100 | 189 | 169 | 0.261985 | 0.359597 | 0.42635 |
| 0007 | 216 | 121 | 42 | 0.511990 | 0.410264 | 0.28767 |
| 0008 | 73 | 91 | 164 | 0.212356 | 0.185440 | 0.11502 |
| 0009 | 193 | 85 | 98 | 0.460549 | 0.311859 | 0.18780 |
| 0010 | 91 | 62 | 107 | 0.286553 | 0.216758 | 0.06458 |
| 0011 | 159 | 186 | 62 | 0.379206 | 0.496810 | 0.43566 |
| 0012 | 230 | 162 | 46 | 0.473785 | 0.443310 | 0.43472 |

2.5 White Point or color of white. D65 white point (Wx=0.3130, Wy=0.3290). A “PASS” shall not exceed DeltaE requirements in Table 2.

2.6 Backlight Brightness. White level luminance equal to or greater than 200 cd/m2 at maximum setting. A “PASS” shall be a white level luminance of >=200 cd/m2.

2.7 References. (1) EBU-Tech 3320: User requirements for Video Monitors in Television Production; (2) EBU tech 3273: Methods of measurement of the colorimetric performance of studio monitors; and (3) IDMS standard: Information Display Measurement Standard (SID-VESA) version 1.03.

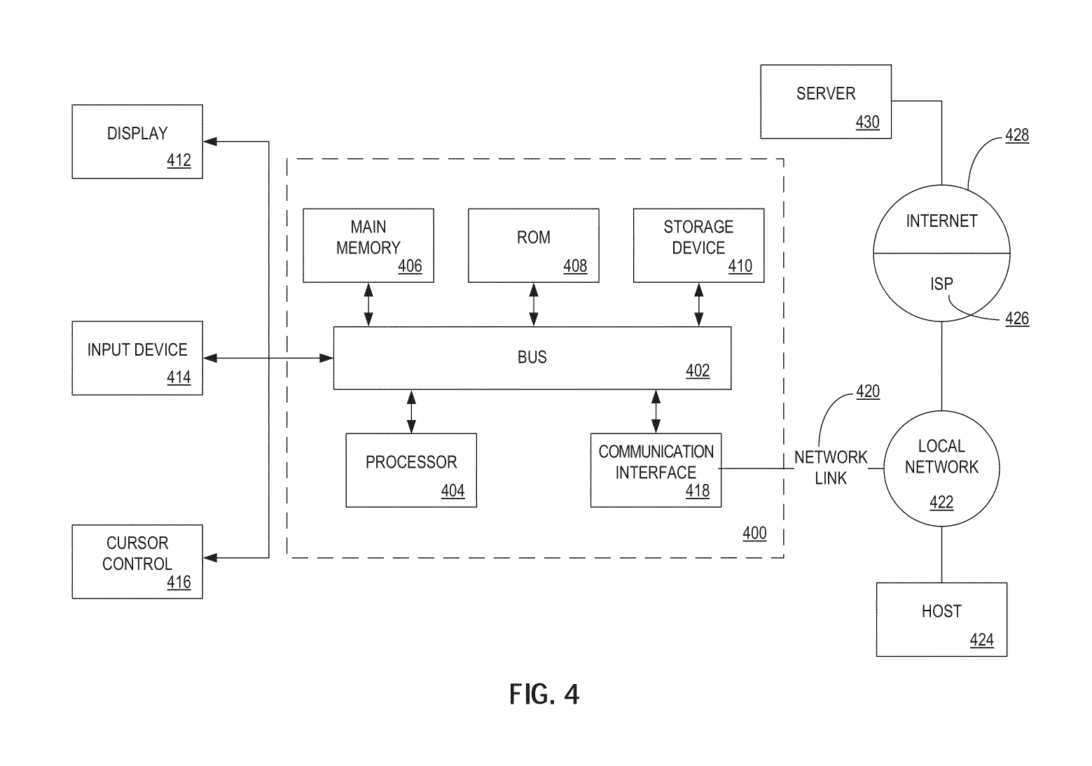

FIG. 4 is a block diagram that illustrates a computer system 400 upon which some embodiments may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk, optical disk, or a flash memory device, is provided and coupled to bus 402 for storing information and instructions.

Computer system 400 may be coupled via bus 402 to a display 412, such as a cathode ray tube (CRT) or liquid crystal display (LCD), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane. In some embodiments, input device 414 is integrated into display 412, such as a touchscreen display for communication command selection to processor 404. Another type of input device includes a video camera, a depth camera, or a 3D camera. Another type of input device includes a voice command input device, such as a microphone operatively coupled to speech interpretation module for communication command selection to processor 404.

Some embodiments are related to the use of computer system 400 for implementing the techniques described herein. According to some embodiments, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments are not limited to any specific combination of hardware circuitry and software. In further embodiments, multiple computer systems 400 are operatively coupled to implement the embodiments in a distributed system.

The terms “machine-readable medium” as used herein refer to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical disks, magnetic disks, or flash memory devices, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, flash memory device, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a data transmission line using a modem. A modem local to computer system 400 can receive the data on the data transmission line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or other internet connection device, or a modem to provide a data communication connection to a corresponding type of data transmission line. As another example, communication interface 418 may be a local area network (LAN) card to provide a data communication connection to a compatible LAN. Wireless network links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the Internet 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A method for changing the color settings of an image on a display comprising the steps of:
displaying an image having known color settings;
providing at least one option for changing the color settings of the image;
receiving a selection of an option for changing the color settings of the image, wherein the option corresponds to an ambient lighting condition; and
displaying the image according to the selected option for changing the color settings of the image.

2. The method of claim 1, wherein the image resides on a website and is viewed on a client device.

3. The method of claim 1, wherein the method is performed by an application that is installed on a client device.

4. The method of claim 3, wherein the image is a digital photograph that was taken by the client device.

5. The method of claim 1, wherein the lighting conditions are selected from a group comprising Illuminants A-F.

6. The method of claim 1, wherein the lighting conditions are selected from a group comprising color of white settings with correlated color temperatures between 2500 and 9000 degrees Kelvin.

7. The method of claim 1 including the additional step of:
providing an option to return to the initial color settings of the image or to change the color settings of the image again.

8. The method of claim 1, wherein the display uses a Monitor Command and Control Set (MCCS) standard and allows for changing color settings white point via Video Electronics Standards Association (VESA) Display Data Channel Command Interface Standard (DDC/CI).

9. The method of claim 1, wherein a lookup table is generated for changing the color settings of the image.

10. A method for changing color settings of an item on a display device comprising:
receiving a webpage containing an image, the image having a correlated color temperature of 6500 degrees Kelvin;
if the image has a correlated color temperature other than 6500 degrees Kelvin, adjusting the correlated color temperature of the image on the device so that it has a correlated color temperature of 6500 degrees Kelvin;
presenting options to change the color settings of the image on the device, wherein the options correspond to correlated color temperatures of various lighting conditions;
receiving a selection of one of the options;
changing the color settings of the image according to the selected option; and
displaying the image according to the selected option, wherein the displayed image on the display has a correlated color temperature of the lighting condition of the selected option.

11. The method of claim 10, wherein changing the color settings of the image occurs on only a portion of the display device.

12. The method of claim 10, wherein the options to change the color settings of the image are selected from a group comprising white points with correlated color temperatures between 2500 and 9000 degrees Kelvin.

13. An application carrying one or more sequences of instructions installed on a client device that implements a method for adjusting color settings on a display device, the method comprising the steps of:
receiving an image having a correlated color temperature;
assessing the correlated color temperature of the image; and
changing the color settings on the device to display the image so that it appears to have a different correlated color temperature.

14. The application of claim 13, wherein the image resides on a web page.

15. The application of claim 13, wherein the image resides on the client device.

16. The application of claim 13, further comprising the step of:
if the image has a correlated color temperature other than 6500 degrees Kelvin, adjusting the correlated color temperature of the image so that it has a correlated color temperature of 6500 degrees Kelvin.

17. The application of claim 13, wherein the changes to the color settings of the display device correspond to lighting conditions.
